(19) United States
(12) Patent Application Publication
(10) Pub. No.: US 2006/0003292 A1
(43) Pub. Date: Jan. 5, 2006

(54) Digital manufacturing of removable oral appliances

(76) Inventors: Mark D. Lauren, Amherst, NY (US); James R. Kunkemoeller, West Seneca, NY (US)

Correspondence Address: HODGSON RUSS LLP, ONE M & T PLAZA, SUITE 2000, BUFFALO, NY, 14203-2391, US

(21) Appl. No.: 11/137,270

(22) Filed: May 24, 2005

Related U.S. Application Data
(60) Provisional application No. 60/573,690, filed on May 24, 2004.

(51) Int. Cl. A61C 5/00; A61C 3/00

(52) U.S. Cl. 433/215; 433/24; 433/213

(57) ABSTRACT

A digitally-based method is described for the design and production of customized removable dental appliances. The plastic component of custom appliances is designed using software, and milled directly over a plaster model of the dentition. A patient's upper, lower, and bite-registered arches are digitized, registered to a bite or centric occlusion position, and articulated in software using either an average geometry or the geometry of a specific articulator. Appliance design is performed by defining the desired plastic surfaces and margins as dictated by the relative movement and positions of the arches as functionally required for a specific appliance. Standard CAM software is used to read the design file and command a multiaxis machine center to mill the plastic while directly on a plaster model.

### CROSS REFERENCE TO A RELATED APPLICATION

Applicants claim priority based on provisional application No. 60/573,690 filed May 24, 2004 and entitled “Digital Manufacturing Of Oral Appliances” which is incorporated herein by reference.

### BACKGROUND OF THE INVENTION

This invention relates to the art of dental appliances, and more particularly to a new and improved method of making removable dental appliances.

Dental appliances make up a diverse group of devices ranging from ceramic orthodontic brackets to soft mouth guards. Some are custom-fitted devices and some are supplied generically to fit a variety of patients. A distinct subgroup of custom-fitted appliances consists of appliances that are removable from the mouth. As a group, removable appliances include orthodontic retainers, occlusal splints, palatal expanders, Herbst appliances, and appliances to relieve sleep apnea. They are produced in commercial dental laboratories as well as in office dental laboratories. As a group, removable appliances provide tooth immobilization, occlusal protection, relief of TMD symptoms, repositioning of the mandible, palatal arch expansion, and other gross dental/skeletal therapeutic actions.

Removable dental appliances are typically made by adapting plastic to a stone model of a patient's teeth. Both hard and soft polymers are used, such as acrylics and silicones. The most commonly used system is methylmethacrylate monomer and polymer (cold cure acrylic). Thermoformed materials are also used. Such appliances also usually incorporate metal as wire, springs, custom fabricated frameworks, pivots, beams, and other mechanical elements. Round wire is typically used to fashion clasps for retention, and for strength.

Removable appliance fabrication typically starts with bending and placing the required wires onto a model. The wires are then embedding in acrylic to form the body of the appliance. The plastic is usually applied in excess, which is then manually trimmed to the desired surface contour, and final polished. Trimming is performed using large bench-mounted abrasive wheels, motorized lathes fitted with stone wheels, and manually-held handpieces. Following trimming, the appliance is typically finished using wet pumice and increasingly fine buffing and polishing steps.

While technicians generally follow specific guidelines for trimming removable appliances, the process remains an art to a certain degree. Applying extra plastic to a model requires less time and skill than minimizing excess, thereby increasing trimming requirements. The quality of the finished product depends upon a technician's skill and attention to detail. Person-to-person variation in quality and speed exists.

### SUMMARY OF THE INVENTION

This invention provides pc-based methods for designing and trimming the body of removable dental appliances. Appliance design is performed in a computer, and computer-controlled machines are used to mill the body of the appliance. The advantages include improved uniformity of design and final shape, reduced trimming time, integration with digital diagnostic information to enhance design, and ability to provide digitally-based design input from the prescribing doctor.

The methods of this invention are based upon the following basic process:
1. Modeling the Dentition
   Producing a 3-dimensional (3D) representation of a patient's dentition and oral soft tissue in a computer.
2. Appliance Design
   Software is first used to articulate the models to allow the simulation of functional movements required for appliance design. Custom software is then used to design the appliance. A computer file is produced that describes the desired surface geometry and margins of the appliance.
3. Appliance Production
   Standard CAM software is used to read the design file so generated and produce the machine tool paths required to mill the desired plastic component or appliance.

Turning first to modeling the dentition, the 3D representation of a patient's oral structures may be produced by a number of methods well known in the art, for example:
a) Optically scanning a stone model produced from an oral impression,
b) Using serial section destructive techniques,
c) Directly scanning the mouth, or
d) Scanning an oral impression
   Each of these methods, and others, are appropriate for producing a digital representation of a patient's dentition suitable for appliance design. The specific method and file type generated is not important to the execution of this invention.

Typically, individual upper and lower models are scanned. A combination scan is also performed of both models together (either in centric occlusion or with a bite in place). These three files are generally sufficient to then articulate a case. Facebow mounted models (for a specific articulator) may also be used by referencing the 3D data to the model's mounting plate, and dimensionally relating the plates to any specific articulator. Any condylar hinge geometry may be included in the articulation.

Turning next to appliance design, it is concerned with defining the plastic components of an appliance, which requires custom software. If the upper and lower models must be articulated, then articulation is performed by computer prior to design. A computer file is produced which represents the desired shape (surface and margins) of the appliance. For a basic occlusal splint, the design process produces a standard 3D file (*.stl or *.iges) that can be displayed as a 3D object in a computer or imported into CAM software for manufacturing.

Broadly, the user first selects the type of removable appliance to be designed. Then, key anatomic locations on the 3D model are identified by clicking on the model on the computer screen. These points are used to construct the 3D surface of the device based upon specific dental rules or design algorithms. These algorithms can serve as templates to facilitate the design of specific classes of appliances. The plastic thickness at a specified location or the desired contour over a specified area may be automatically generated. Software also provides the capability of modifying the surface and margins.

A generalized description of the basic design tools is provided. These tools are combined to create design software specific to a single type of appliance. In a preferred embodiment, appliance design software utilizes tools that include:
Modeling the articulation to allow the lower arch to be moved. This is required when modeling the arcs and paths of tooth movement in response to appliance-specific excursions of the mandible.
Defining the margins of an appliance by clicking a series of points on the 3D model.
Defining and moving occlusal planes.
Extending surfaces off the dental model that are bordered by the appliance margin.
Modifying the height and contour of the extended surface in relation to the opposing arch.
Identifying contact points and sliding arcs on an opposing arch.
Software to consider the location of wires in an appliance during trimming
   The computer file so produced contains the 3D information describing the appliance surface and margins to be trimmed.

Turning finally to appliance production, the specific type of plastic for a removable appliance is adapted to a plaster model in excess which is milled away to produce the desired appliance surface. Standard CAM software may be used to convert the design file into the required tool paths to mill excess plastic and produce the desired surface. Since the plastic is already adapted to the complex anatomy of the teeth, detailed dental anatomy does not have to be milled. This greatly reduces the size of the design file and the complexity of the geometry to be machined. Typically, a multi-axis machine center is used to mill the appliance. A three axis system may be capable of producing the majority of cases, while a four or five axis system is required to produce undercut regions.

### BRIEF DESCRIPTION OF THE DRAWING FIGURES

FIG. 1 is a block diagram of the basic processes of this invention using an occlusal splint as an example.

FIG. 2 is a computer image of an example combination scan. This image shows a single front laser scan of two models placed in centric occlusion. The upper model (10) and lower model (20) are shown together. The upper model is marked with crosses (30) to aid with registration. The lower model is marked with open circles (40). Sufficient detail is captured of the upper and lower models to allow registration of the upper and lower complete scans.

FIG. 3 is a computer image which illustrates complete upper and lower models (60) registered to each other according to the combination scan in FIG. 1. The occlusal plane of the lower model is also shown (50). Two separate files (upper and lower complete model scans) are shown together.

FIG. 4 is a diagrammatic right saggital view diagramming the geometric parameters used to establish the hinge axis for unmounted models using a lower model. A cusp on a distal molar (100) and the tip of a central incisor (110) are used to establish a lower occlusal plane (120), which is set to a default angle (130) of 15° to the horizontal. The axis-incisal distance (140) is defaulted at 100 mm and the vertical height (150) is defaulted to 50 mm. The condyle is modeled as a sphere (160). The concylar inclination angle (170) is defaulted to 20° to the horizontal, and a typical eminence curve is shown as (180).

FIG. 5 is a computer image which illustrates how user-defined points (70) may be located on the teeth to define the margin of the appliance. A spline (80), or other form is generated between the contact points. The curvature, or degree to which the curve adheres to the points, is software controlled. This method may be used to control the degree of undercutting. In this case, the spline (80) is designed offset (90) from the tooth surfaces.

FIG. 6 is a computer image which illustrates the application of PMMA acrylic (190) to half the arch of a plaster dental model (200), capturing the details of the teeth. Excess plastic is applied to allow for milling. The adaptation of acrylic or other plastics to the models is performed using standard laboratory methods.

FIG. 7 is a computer image which shows a centric relation splint (210) produced by the methods of this invention.

### DETAILED DESCRIPTION

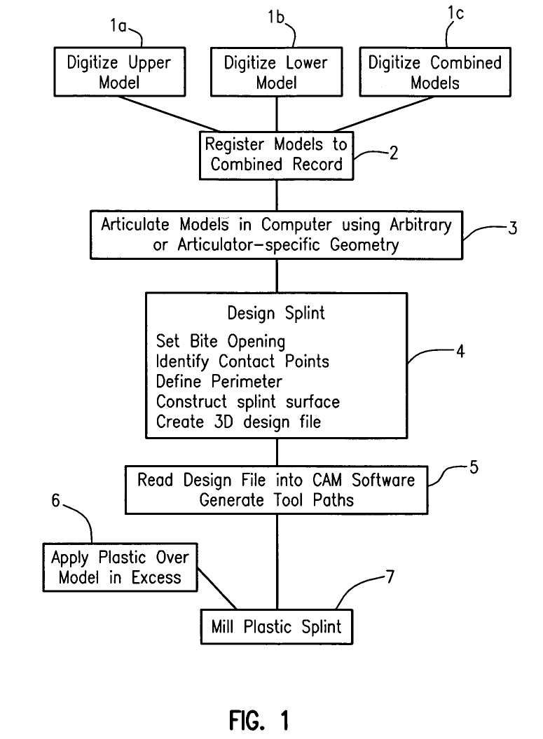

While the basic method described in the foregoing Summary of is applicable to a variety of removable appliance types, details of modeling the dentition, appliance design, and appliance production are described using an occlusal splint as an example. The process for producing an occlusal splint is summarized in FIG. 1. Digital 3D files of the upper, lower and combined models are designated 1a, 1b and 1c in FIG. 1. Registration of the individual upper 1a and lower 1b models to the combination scan 1c is represented at 2. The first step in appliance design, articulation, is shown at 3, and the design process is shown at 4. Appliance production includes generating tool paths 5, applying plastic 6 and milling 7.

Turning first to modeling the dentition, several methods are known in the art for creating a 3D representation of dental anatomy in a computer with sufficient detail to carry out this invention. A preferred method for obtaining a 3D representation of (digitizing) a patient's teeth and soft tissue is laser scanning plaster models. Plaster models are mounted on standard articulator mounting plates to allow easy and accurate relocation from the scanning system to a mounting jig in the machine center. Magnetic attachments may be used. In a preferred embodiment, unmounted lower and upper stone models are plastered to standard bases typically used to attach to dental articulators. Mountings are simply done to a convenient level position. Cases already mounted for a specific articulator are scanned in a similar fashion. These cases, however, have built-in articulation relationships determined by the geometry of the articulator used.

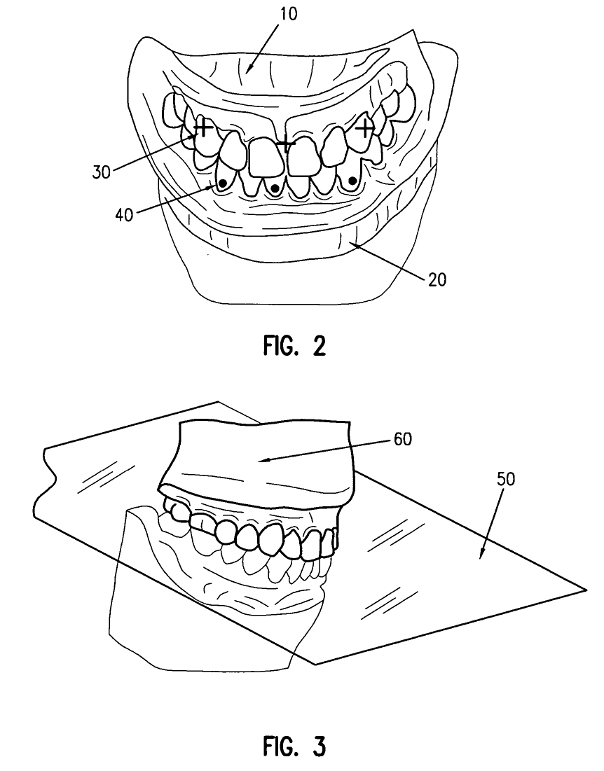

An important aspect of digitizing is having the models in a specific coordinate system. It is critical that that the appliance is designed and machined in coordinate systems with a known relationship to each other. The model mounting plate is a convenient reference to use. This reference allows the arches to be re-positioned in a computer to duplicate their relative positions when placed on any articulator. The model base reference also provides convenient work planes for machining. The identification and definition of this coordinate system is performed by scanning a calibration block whose surfaces can be related to the model base. For a rotary laser scanning system, one of the scans is performed in an identical position as the calibration block. This scan then serves as the fixed object to which subsequent scans are registered and merged. This method produces digital 3D files of the upper, lower, and combined models with a consistent coordinate system amenable for articulation, design, and machining. Thus the combination scan of FIG. 2 shows the upper 10 and lower 20 models. In general, models may be transformed to alternate original coordinate system to suit typical variations of the given method.

Another important feature of digitizing is the registration of the individual upper and lower models to the combination scan. Such registration is shown in FIG. 3. Registration may be accomplished by a variety of well known surface matching techniques. These methods are typically based on: 1) defining the combination scan as a fixed object and either the upper or lower model as a floating object, 2) identifying corresponding points on the fixed and floating objects, and 3) comparing the surfaces surrounding these points to align and reorient the objects. A system of colors, crosshairs, or other recognizable optical targets may be used to provide the means for more automated registration. By way of illustration, the crosses 30 and circles 40 of FIG. 2 function as such registration aids.

Turning next to appliance design, similar design tool and procedures are used for all removable appliances. The first step, if needed, is always articulation. Sufficient articulation geometry must be defined for design to take place. This information is typically the location of a hinge axis and modeled condylar detail.

The generalized design process of this invention involves the following elements. Some appliances do not require the use of all of these design elements:
Evaluation of mandibular repositioning and excursions—The lower dental arch is moved in concert or repositioned to simulate positions for appliance design. This process models in space the arcs and swept surfaces of tooth movement in response to mandibular excursions.
Defining occlusal planes on the digital models to provide reference surfaces for design.
Defining an appliance margin using a template of points that automatically generates the desired perimeter.
Building surfaces off the dental model that are bordered by the appliance margin.
Identifying tooth/appliance contact points and surfaces based upon an opposing arch.
Defining appliance margins by clicking points on the 3D model.
Identifying the location of wires in an appliance during trimming. Wires that are imbedded in plastic should have known or assumed distances from the surface. Wires that extend out of the plastic surface should have known locations.
   The registered upper and lower scans are read into custom CAD software that allows a user to articulate the models and design an appliance. The result of appliance design is a computer file that contains the 3D information describing the desired appliance surface and margins.

Removable appliance design typically begins with articulation. Articulation may be performed in a variety of ways based on slightly different dental rules. In a preferred embodiment, articulation is considered for mounted and unmounted cases. Mounted cases are models that are provided to the laboratory already plastered to a mounting for a particular articulator. A bite registration may also be provided. A doctor has typically taken a facebow recording of the true position of the upper and lower dental arches relative to the cranium, and transferred that position to the mounting. This mounting therefore contains all the jaw orientation data required for articulation when the models are positioned as they would be on a particular articulator. This is done in a computer by simply modeling the geometry of a particular articulator, which may include articulation joint geometry. Rotating and or translating the lower model relative to the fixed upper is then performed to simulate classically mounted models.

Unmounted cases are provided to the dental laboratory as either impressions or plaster models. A bite registration may be provided. The articulation of unmounted cases is more involved since the mounts do not contain any patient-specific information. In a preferred embodiment, unmounted cases are articulated to an average geometry. Models are poured to a convenient low height and are plastered to a standard articulator base plate in a generally horizontal position. Upper, lower, and combination scans are obtained.

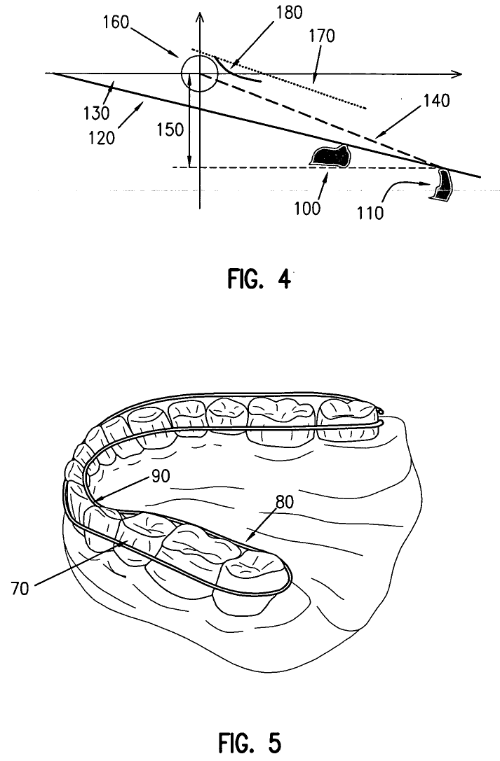

In a preferred embodiment, unmounted models are articulated in the computer as follows. Following registration of the upper and lower models to the combination scan, an occlusal plane is defined on the lower model. This may be done by identifying three points on the lower model and calculating the resultant plane. Typically, the distal buccal cusps of the left and right second molars are used as well as the midline tip of the central incisors (for example, 100 and 110 in FIG. 4). The jaw midline should be used and not the dental midline if they are significantly different. The lower occlusal plane (120 in FIG. 4) is then inclined at a settable angle to the horizontal, typically about 150 (the angle 130 in FIG. 4). To locate a hinge axis, two additional pieces of information are used: 1) the tip of lower central incisor is located at a point (settable) about 100 mm normal to the hinge axis (140 in FIG. 4), and 2) the vertical height from the incisal tip to the hinge axis (settable) is about 50 mm (150 in FIG. 4). The occlusal plane angle, axis-incisal distance, and vertical height are used to establish the location of a hinge axis.

No additional articulation geometry is required for the design of flat plane splints, and the condyle maybe modeled as a simple hinge in centric relation. Centric relation splints and other appliances require more detailed modeling of the TMJ.

More detailed modeling of the TMJ is required to design centric relation splints since the mandible must be translated anteriorly as well as side-to-side. At least three additional parameters may be built into the TMJ modeling: the condylar inclination angle (170 in FIG. 4), an eminence ramp (180 in FIG. 4) along the condylar incline, and a sideways Bennet angle function. Some fully-adjustable articulators allow these three parameters to be set. Similarly, specific geometry may be modeled to duplicate the settings of specific mechanical articulators.

The tooth contact surface is the most important of aspect of an occlusal splint. Following articulation, the next step in splint design is establishing desired bite opening. With both models articulated and visible on a computer screen, the lower jaw is rotated around the hinge axis to open the bite. The models are typically viewed from the left or right buccal side so as to look through the occlusion. This view allows the user to visualize the open space across the arches, ensuring sufficient plastic thickness over the teeth and the absence of side to side sliding interferences. A measuring tool in software may be used to measure distance on the computer screen. Alternatively, software may be used to open the bite a minimum specified distance. Once the bite is set, the splint is designed and built to that opening.

The location of the contact points of the teeth of the opposing arch is then determined to establish the occlusal surface of the splint. All teeth should contact the splint surface when the mouth is closed in centric rotation. The contacts on the opposing teeth may be locating by:
1) manually clicking on a model surface to identify a location,
2) using software to optimize manually positioned points by relocating the point to the most occlusal location on the tooth parallel the occlusal plane, or
3) passing an occlusal plane through a model surface to identify the cusp locations that first break through the moving plane
   Centric relation splint design requires the lower arch to be moved through a variety of excursions to identify the sliding surfaces required to ensure desired disclusion of the posterior teeth when the jaw is moved (left to right as well as normal opening). These motions are readily simulated in the computer since all of the needed geometry exists to identify the required pivot points and angles. The appliance occlusal surface is designed to have point contact of the posterior teeth (bicuspids back) and a gliding or line contact of the anterior teeth.

Joining the appliance occlusal surface with the appliance margin is an important process. Penetration into the interproximal region is also controllable. The desired degree of interproximal penetration varies with appliance type and design for specific patients. Consideration of the path of insertion may be used to control the degree undercuts to be overcome by the appliance during insertion by the patient. Different appliance materials have different abilities to fit over undercuts. When the joining the appliance occlusal surface and margin is complete, a computer file is created that describes the margins, sides, and occlusal surfaces of the appliance. As shown in FIG. 5, points 70 define the margin of the appliance, and a spline 80 is designed with offset 90.

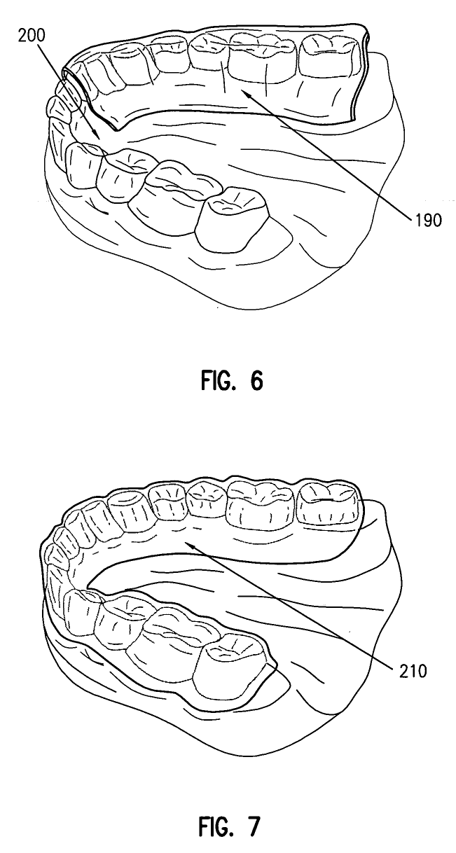

Turning finally to appliance production, production of the desired appliance, or appliance component, is preferably achieved by commanding a machine center to mill the excess plastic over a physical model, for example acrylic 190 applied to model 200 in FIG. 6. Commercially available CAM software may be used to read the design file and generate the appropriate tool paths needed for milling. The optimum combination of tool shapes, tool paths, and speeds is a tradeoff between trimming time and the required surface finish.

In a preferred embodiment, when machining soft heat-sensitive polymers, the work piece may be cooled with air or liquids to prevent the material from heating. In another alternate embodiment, the model may scanned following application of the initial plastic to determine the amount and shape of the material to be removed. This can help optimize the choice of tools and tool paths, particularly for initial roughing.

While embodiments of the invention have been described in detail, that has been done for the purpose of illustration, not limitation.

1. A method of producing custom removable dental appliances comprising:
a) obtaining a 3-dimensional digital record of the upper and lower dentition, including a combination record, said combination record consisting of 3-dimensional digital data that represents the upper and lower arches together in either a bite position or centric occlusion;
b) registering the upper and lower models using the combination record as reference to produce a digital record of the complete upper and lower dental arches approximated in either a bite or centric occlusion relationship;
c) using software to articulate the upper and lower models in a computer to enable sufficient repositioning of the models to facilitate the design of a removable dental appliance;
d) using software to design the surface and margins of the plastic component of a removable dental appliance and produce an associated 3-dimensional data file; and
e) using CAM software to read the design file and generate the tool paths required to mill the desired plastic shape using a machine center.

2. The method according to claim 1 wherein the appliance is an occlusal splint, orthodontic retainer, sleep apnea appliance, or Herbst framework.

3. A removable dental appliance made according to the method of claim 1.

4. The method according to claim 1 wherein the 3-dimensional record of the dentition is obtained by laser scanning plaster models mounted to plastic articulator bases; the registering of the upper and lower models is facilitated by target markers applied or related to the upper and lower models prior to digitizing;

5. The method according to claim 1 further comprising providing software to a doctor to facilitate his providing digital design information related to the articulation or design of a patient-specific removable dental appliance.

6. The method according to claim 1 wherein the milling of the desired plastic shape is performed.

7. The method according to claim 1 wherein the design of the appliance comprises:
a) controlling the degree of undercutting of the plastic to ensure a proper fit to the patient,
b) moving an occlusal plane down over the surface of a model to identify points of first contact on cusp tips to aid in the design of occlusal splints, and
c) identifying the location of wires in an appliance to avoid cutting the wires during the milling process.

8. The method according to claim 1 further comprising smoothing the machined plastic surface using an abrasive tool in the milling machine to provide a finer surface finish.

9. The method according to claim 1 wherein the milling machine is a 3, 4, or 5 axis machine center.

10. The method according to claim 1 further comprising adapting plastic to a dental model to allow the excess to be milled away to produce the desired dental appliance, said plastic ranging from hard acrylic to soft silicone, and including thermoformed material as part or all of the plastic component.

11. A computerized method of producing removable dental appliances comprising:
a) producing a 3-dimensional digital representation of a patient's dentition and oral soft tissue;
b) utilizing the digital representation to simulate functional movements required for an appliance design;
c) utilizing the simulated functional movements to provide a design file describing surface geometry and margins of an appliance; and
d) utilizing the design file to produce machine tool paths to make the appliance.

12. The method according to claim 11, wherein the digital representation includes upper and lower jaw models and a combination model thereof.

13. The method according to claim 11, wherein simulation of functional movements includes modeling the patient's articulation.

14. The method according to claim 11, wherein the surface geometry and margins are defined relative to occlusal planes, surface height and contour in relation to an opposing arch and contact points and sliding arcs on an opposing arch.

15. The method according to claim 11, wherein the machine tool paths are utilized by a multi-axis milling machine.

16. A removable dental appliance made according to the method of claim 11.
